(19) United States
(12) Patent Application Publication
(10) Pub. No.: US 2023/0392861 A1
(43) Pub. Date: Dec. 7, 2023

(54) SYSTEM FOR COOLING AND CONDENSING GAS

(71) Applicants: FUNDACIÓN UNIVERSIDAD DEL NORTE, Barranquilla (CO); PROMIGAS S.A. E.S.P., Barranquilla (CO)

(72) Inventors: Luz Marlen AHUMADA CASTRO, Barranquilla (CO); Miguel PADILLA MARTES, Barranquilla (CO); Johan Antonio ARENAS BUSTAMANTE, Barranquilla (CO); Julio Alberto MEDINA SUAREZ, Barranquilla (CO); Marco Enrique SANJUAN MEJÍA, Barranquilla (CO); Cinthia Paola AUDIVET DURAN, Barranquilla (CO); Antonio José BULA SILVERA, Barranquilla (CO); Iván Darío GÓMEZ MOSQUERA, Barranquilla (CO); Nestor Nabonazar DURANGO PADILLA, Barranquilla (CO)

(21) Appl. No.: 17/419,564

(22) PCT Filed: Oct. 17, 2019
(86) PCT No.: PCT/IB2019/058839

§ 371 Date: Jun. 29, 2021

(30) Foreign Application Priority Data
Dec. 29, 2018 (CO) NC2018/0014386

(51) Int. Cl. F25J 1/02; F25J 1/00

(52) U.S. Cl. CPC F25J 1/0232; F25J 1/0272; F25J 1/004; F25J 1/0022; F25J 1/0201; F25J 2205/10; F25J 2210/06; F25J 2240/40; F25J 2240/60

(57) ABSTRACT

The present invention corresponds to a gas cooling and condensing system using fluid energy and comprising a gas feed line, a first vortex tube connected to the gas feed line, a second vortex tube connected to the first vortex tube and a first heat exchanger connected to the second vortex tube and to the gas feed line. Said gas cooling and condensing system is a modular system, which may be replicated and connected in series or in parallel to another modular system to obtain a cooler or higher mass flow gas than that obtained with a single modular system.

Moreover, the system of the present invention is optionally connected to thermal recovery, pressure recovery, recirculation or venting elements for the utilization of the waste gas streams. Furthermore, the system of the present invention does not require additional energy to that obtained from the pressure of the feed line for obtaining liquefied gas. On the other hand, the system of the present invention taps the pressure drop required between the compressed gas transport and distribution activities.

### FIELD OF THE INVENTION

The present invention relates to systems cooling and condensing of pressurized gas, specifically natural gas.

### DESCRIPTION OF THE PRIOR ART

In the prior art there are documents disclosing related devices with assistive technology such as those taught in patent documents RU2258186C1 and U.S. Pat. No. 6,932,858B2, and in the publication INNOVATION FOR SUSTAINABLE ENERGY retrieved from: https://hub.wsu.edu/ise/design/precooling/ in October 2018.

RU2258186C1 discloses a natural gas liquefaction process for automotive gas filling compressor. According to the proposed method, natural gas from the network is at a pressure of p<=7.6 MPa, compressed to a high pressure of p<=25 MPa and then successively cooled in a first heat exchanger and then in a second heat exchanger, and then delivered to a storage device, wherein the gas is separated into liquid and gas phase. The gas phase is returned to the inlet of a compressor through the second and first heat exchanger. The high-pressure gas, (p<=25 MPa), is cooled in the first heat exchanger by cold flow from a preliminary cooling circuit in which at least one stage is used as an additional cooling source. Said stage consists of at least one recuperative heat exchanger and at least two vortex tubes operating with the pressurized gas, (p<=7.5 MPa), arriving from the network. The “cold” flow from the first vortex tube is fed to the medium pressure line of the preliminary cooling circuit heat exchanger. The pressurized gas, (p<7.5 MPa), cooled in said preliminary heat exchanger, is supplied to the inlet of the second vortex tube, its “cold” flow is mixed with a reverse flow of unliquefied gas in the cycle, from the outlet of the second heat exchanger and it is directed to the inlet of the medium pressure line (p<=1.6 MPa) of the first heat exchanger, in that exchanger the direct flow of high-pressure gas (p<=25 MPa) is cooled to a temperature T<245 K, and then passed to the second heat exchanger. Moreover, the “hot” flows of vortex tubes are joined and directed to the outlet network of the gas distribution station, by means of an ejector.

Said document RU2258186C1 presents arrangements of vortex tubes connected to heat exchangers, but not arrangements of vortex tubes connected to each other. Moreover, the initial pressure of the fluid used as coolant and the fluid to be cooled are different. On the other hand, the disclosed process requires the use of at least one compressor.

On the other hand, document U.S. Pat. No. 6,932,858B2 discloses a method and system for processing natural gas in which a natural gas stream comprising a hydrocarbon mixture is introduced into at least one vortex tube, obtaining a hot fluid stream and a cold fluid stream. The cold fluid stream is introduced into the upper section of a distillation column and the hot fluid stream is introduced into the lower section of the distillation column, resulting in an improved separation between the heavier and lighter components of said natural gas.

In turn, the publication INNOVATION FOR SUSTAINABLE ENERGY discloses a compression cycle followed by three vortex tubes. Each vortex tube is fed by both the feed gas and the hot outlet of the next vortex tube, after it has undergone a heat exchange process with the gas leaving the cooling portion. The compression cycle of such a publication is a closed cycle, i.e., the working fluid is not a downstream feed stream.

Moreover, in the prior art there are also known gas cooling and condensation systems using compressors or other systems with external energy supply, which have the disadvantage of requiring higher costs for their operation.

### BRIEF DESCRIPTION OF THE INVENTION

The present invention corresponds to a gas cooling and condensation system which uses the energy of the fluids to be processed, without external energy input, and comprises a gas feed line, a first vortex tube connected to the gas feed line, a second vortex tube connected to the first vortex tube and a first heat exchanger connected to the second vortex tube and to the gas feed line. Said gas cooling and condensing system is a modular system, which may be replicated and connected in series or in parallel to another modular system to obtain a cooler or higher mass flow gas than that obtained with a single modular system.

Moreover, the system of the present invention is optionally connected to thermal recovery, pressure recovery, recirculation or venting elements for the utilization of waste gas streams.

### BRIEF DESCRIPTION OF THE FIGURES

FIG. 1 illustrates the cooling and condensing system of the present invention, which represents a modular system.

FIG. 2 illustrates one embodiment of the system of FIG. 1 wherein an additional vortex tube is included.

FIG. 3 illustrates one embodiment of the cooling and condensing system wherein two modular systems are connected in series.

FIG. 4 illustrates a cooling and condensing system embodiment wherein two modular systems are connected in parallel.

FIG. 5 illustrates one embodiment of the system of FIG. 1 wherein pressure regulating valves are included.

FIG. 6 illustrates one embodiment of the system of FIG. 1 wherein pressure regulating valves and an ejector are included.

FIG. 7 illustrates one embodiment of the system of FIG. 1 wherein an expansion valve and a separation and storage device are included.

FIG. 8 illustrates one embodiment of the system of FIG. 1 wherein pressure regulating valves, an ejector, an expansion valve, and a separation and storage device are included.

FIG. 9 illustrates one embodiment of the system of FIG. 3 wherein pressure regulating valves are included.

FIG. 10 illustrates one embodiment of the system of FIG. 3 wherein pressure regulating valves and an ejector are included.

FIG. 11 illustrates one embodiment of the system of FIG. 3 wherein an expansion valve and a separation and storage device are included.

FIG. 12 illustrates one embodiment of the system of FIG. 3 wherein pressure regulating valves, an ejector, an expansion valve, and a separation and storage device are included.

FIG. 13 illustrates one embodiment of the system of FIG. 1 wherein a second gas feed line is included.

FIG. 14 illustrates one embodiment of the system of FIG. 1 wherein a second gas feed line and a third vortex tube are included.

FIG. 15 illustrates one embodiment of the system of FIG. 1 wherein pressure regulating valves, an ejector, an expansion valve, a separation and storage device and a third heat 25 exchanger are included.

FIG. 16 illustrates a preferred embodiment of the cooling and condensing system of the present invention.

FIG. 17 is a graph illustrating the pressure and enthalpy values in an example of a cooling and condensing system of the present invention.

### DETAILED DESCRIPTION

In the gas production, treatment, transport and distribution industry, the cooling and condensation of gases is a process known to demand large amounts of energy. This energy input may be electrical or thermal and constitutes a considerable operating cost throughout the life cycle of the systems.

On the other hand, it is known that during the transport of gases these must have a high pressure to obtain a higher mass flow. However, when the gas has reached its destination, its pressure must commonly be reduced to be distributed and consumed. In order to reduce the pressure of a gas it is necessary to use valves and devices, through which the gas cools down as a natural consequence of the pressure reduction, this cooling is usually not tapped and the pressure drop energy is not used in any application. In some cases, the pressure reduction takes place in devices called turboexpanders, in which the pressure reduction is used to generate a rotational movement of a shaft, which coupled to a generator allows obtaining electric energy.

This invention considers the context of an industrial process in which there is a gas with a high pressure that may or must be reduced, and concurrently there is the need or opportunity to cool and condense a gas stream. The device of the present invention takes advantage of the pressure drop suffered by the gas in a system to carry out cooling and condensation processes of the same gas or other gases, without external input of electrical or thermal energy, thus allowing the cooling and condensation process to be carried out with low operational costs.

If the pressure drop is carried out in a traditional regulating valve, the tube that houses the gas will not be able to capture this cooling capacity, so the outside of the tube cools down, sometimes to the point of freezing, and the gas increases its temperature again and continues its journey through the pipe. In the present invention, this pressure drop is carried out in vortex tubes which allows a greater cooling effect and a more suitable configuration for the use of the cold stream.

By not requiring additional energy to cool and condense the gas, the production of liquefied gas on a small scale becomes feasible; i.e., the production of liquefied gas quantities on scales that would not be cost-effective with external energy input. In one invention embodiment, the system of the present invention uses additional energy only to power auxiliary systems, such as measurement and control systems.

The present invention consists of a fluid cooling and condensation system consisting of vortex tube arrays and heat exchangers.

For the understanding of the invention, the fluids treated are gases. For example, such gases are selected from carbon dioxide (CO2), carbon monoxide (CO), chlorine (Cl2), hydrogen (H2), hydrogen chloride (HCl), methane (CH4), ethane (C2H6), butane (C4H10), nitrous oxide (N2O), propane (C3H8), sulfur dioxide (SO2), argon (Ar), nitrogen (N2), water vapor (H2O), oxygen (O2), helium (He), krypton (Kr), neon (Ne), xenon (Xe), natural gas or mixtures thereof.

In one embodiment of the invention the system allows to obtain natural gas in liquid state at low pressure for commercial use (p<413.6 kPa) and with the aforesaid characteristic of not requiring additional electrical or thermal energy to that given by the potential energy difference (pressure differential) between the supply line and the final storage pressure.

The present invention consists of a gas cooling and condensing system, comprising a gas feed line, a first vortex tube connected to the gas feed line, a second vortex tube connected to the first vortex tube and a first heat exchanger connected to the second vortex tube and to the gas feed line, where the gas cooling and condensing system is a modular system, meaning it may be replicated and connected to another such modular system.

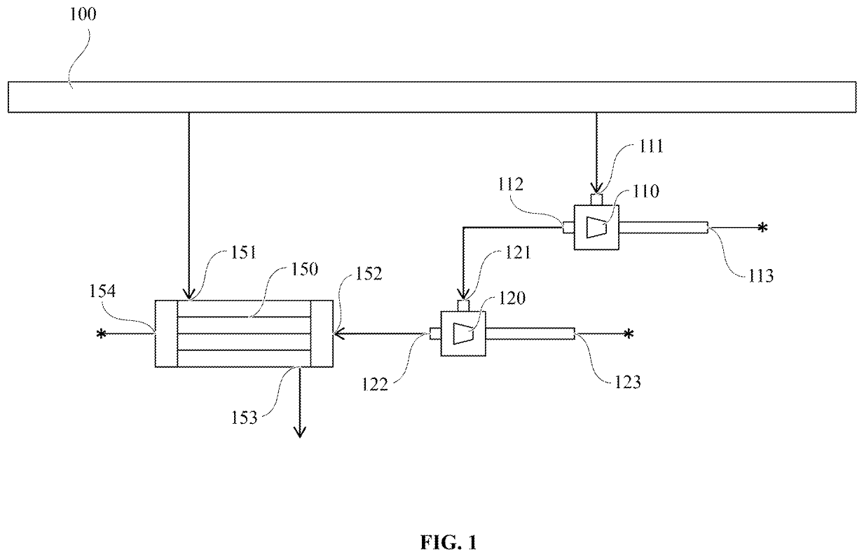

Referring to FIG. 1, in one embodiment of the invention, the system comprises a first vortex tube (110), a second vortex tube (120) and a first heat exchanger (150). Both the first vortex tube (110) and the second vortex tube (120) have an inlet (111, 121), a first outlet (112, 122) and a second outlet (113, 123). The inlet (111) of the first vortex tube (110) is connected to a gas feed line (100) and the inlet of the second vortex tube (120) is connected to the first outlet (112) of the first vortex tube (110), this generates a thermal and mass cascade.

On the other hand, the first heat exchanger (150) has two inlets (151, 152) and two outlets (153, 154), a first inlet (151) connected to the gas feed line (100) and a second inlet (152) connected to the first outlet (122) of the second vortex tube (120). The cooled gas exits the first outlet (153) of the first heat exchanger (150) and the gas used as refrigerant exits the second outlet (154) of the first heat exchanger (150).

Regarding the gas supply line (100) this is selected between a continuous supply line (e.g. by means of a piping system) or a discontinuous supply line (e.g. using tanks or containers), with a regulated or variable supply pressure level between 1.0 and 25 MPa, preferably between 4.0 and 6.5 MPa.

On the other hand, vortex tubes are devices that have no moving parts, into which a high-pressure gas enters and separates into two streams of lower pressure than the inlet gas pressure. One of the streams exits at a higher temperature than that of the inlet gas (high temperature outlet) and the other stream exits at a lower temperature than that of the inlet gas (low temperature outlet). For the understanding of the present invention, the low temperature outlets of the vortex tubes will be referred to as “first outlet” and the high temperature outlets of the vortex tubes will be referred to as “second outlet”.

Due to the internal geometry of the vortex tube, the gas enters tangentially to the longitudinal axis of the vortex tube, thereby inducing a spin in the incoming stream, and subsequently a separation in the two gas streams mentioned above. The faster rotating fluid loses heat, hence cools down more. This process is accompanied by a pressure drop.

Usually, and as found in the industry, the vortex tube output stream tapped is that from the high temperature outlet, which is used for drying of other substances. In the present invention, it is the stream from the low temperature outlet that is tapped.

On the other hand, the heat exchangers (150, 160 and 170) used in the present invention are selected from the group consisting of direct contact exchangers, indirect contact exchangers, reciprocating exchangers, surface exchangers, plate exchangers, tube exchangers, shell and tube exchangers, concentric tube exchangers, cross-flow exchangers, parallel flow exchangers, co-stream exchangers and counter-stream exchangers.

In a preferred embodiment of the invention, the heat exchangers (150, 160 and 170) are shell and tube heat exchangers. Said heat exchangers have a counter-stream flow direction, and the cooling fluid flows through the tubes, while the fluid to be cooled flows through the shell. These heat exchangers are closed, so the fluids do not mix. The pressure of the fluid to be cooled varies between 1.0 to 25 MPa, while the pressure of the cooling fluid varies between 100 kPa and 25 MPa. In the preferred embodiment of this invention, the pressure of the fluid to be cooled varies between 4.0 and 6.5 MPa, while that of the cooling fluid varies between 400 kPa and 6.5 MPa.

Referring again to FIG. 1, the stream coming out of the first outlet (122) of the second vortex tube (120) presents low temperature and low pressure with respect to the gas that entered through (111). However, said stream coming out of (122) is far from the condensation zone, so a better use for it is as a coolant for the stream coming from (100) which maintains the high pressure, so it is more prone to reach condensation. In order to cause the gas cooling and condensation, the two streams coming from (100) and (122) are introduced into the first heat exchanger (150), achieving the cooling of the stream coming from (100) with a negligible decrease in its pressure.

It is important to mention that the state of the cooled fluid leaving through the first outlet (153) of the first heat exchanger (150) depends on the nature of said fluid, therefore it is possible to obtain a fluid in liquid, gas state or a mixture of both. However, this fluid is thermodynamically closer to the condensation zone which makes it more suitable for obtaining liquids at low pressure. This partially condensed fluid may be separated and to take its gas fraction to an expansion valve where more liquid is obtained. This cooled gas leaving the outlet (153) is used as a refrigerant for industrial applications or is further cooled to a liquid state.

On the other hand, the stream exiting (154) may be vented, recovered or recirculated as explained later.

Accordingly, the system shown in FIG. 1 is known as a modular cooling and condensing system and consists of a thermal and mass cascade of two vortex tubes and a heat exchanger. This module allows obtaining a fluid at high pressure, cooled, condensed or with partial condensation.

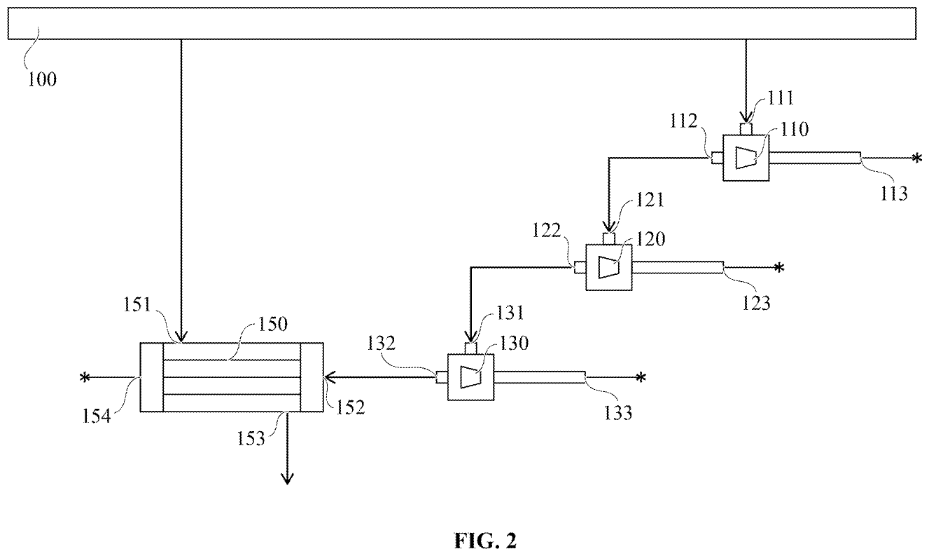

In one embodiment of the invention the thermal and mass cascade may comprise more than two vortex tubes. This is possible and useful depending on the percentage of pressure drop available from the gas to be condensed. Referring to FIG. 2, the system of the invention includes a thermal and mass cascade with a first vortex tube (110), a second vortex tube (120) and a third vortex tube (130) delivering a refrigerant gas to the first heat exchanger (150).

In some applications of the invention and according to the properties of the treated gases a colder gas or with higher mass flow is required. In order to solve these requirements, it is possible to connect two modules in series or in parallel as explained below:

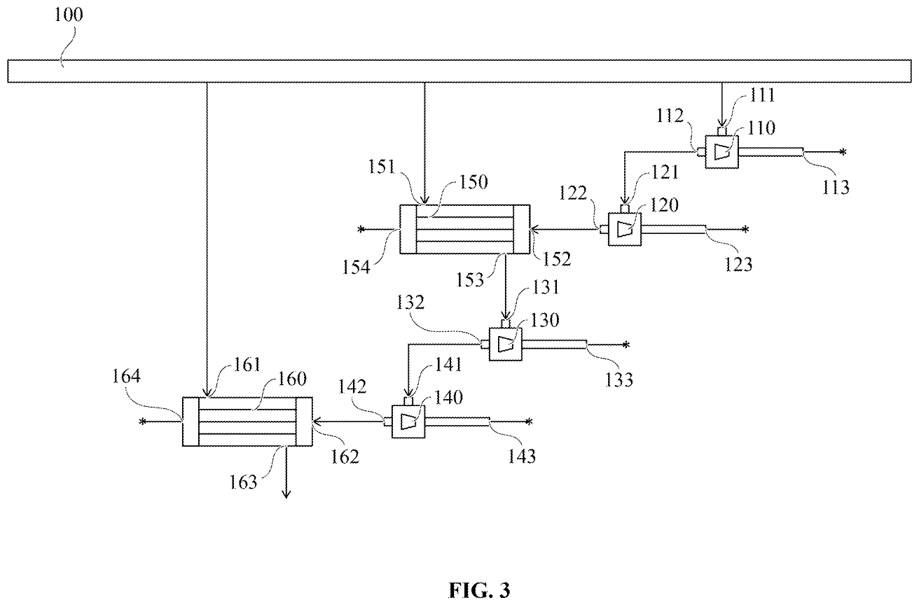

Referring to FIG. 3, in one embodiment of the invention the first heat exchanger (150) is connected a third vortex tube (130), said third vortex tube (130) is connected to a fourth vortex tube (140), and a second heat exchanger (160) is connected to the fourth vortex tube (140) and to the gas feed line (100). In this case the system is configured with the series connection of two modular systems.

According to the foregoing, the gas stream leaving the first outlet (153) is connected to another cooling module to continue decreasing its temperature. This is possible because its pressure continues to be the same as that of the gas supply line (100), since its passage through the first heat exchanger (150) does not substantially affect its pressure and only lowers its temperature.

Referring again to FIG. 3, in one embodiment of the invention, the gas stream exiting the second outlet (133) of the third vortex tube (130) is at the same pressure as the gas stream exiting the second outlet (113) of the first vortex tube (110), these streams joining and forming an intermediate pressure line. Moreover, the gas stream exiting the second outlet (123) of the second vortex tube (120) is at the same pressure as the gas stream exiting the second outlet (143) of the fourth vortex tube (140), these streams merge and form a low-pressure line.

The stream coming out of the first outlet (142) in the fourth vortex tube (140) is even colder than the stream coming out of the first outlet (153) in the first heat exchanger (150). Said stream coming from the first outlet (142) is used to cool the gas arriving to the second heat exchanger (160), obtaining a cooler stream than the one coming from the first outlet (153) and with the same pressure of the gas feed line (100).

The number of modular systems to be configured in series is given according to the required application or as technically and economically feasible. In a preferred embodiment of the invention, two to four modular systems are connected in series. It should be noted that the more modular systems are included, the more high-temperature outputs will be obtained, which may be a disadvantage if there is no use for the low-pressure and intermediate-pressure streams coming from such outputs, which would be considered system waste. In an example of the invention, said low and intermediate pressure streams are tapped by recirculating and/or recovering their pressure and/or temperature within the system. This will be further detailed below.

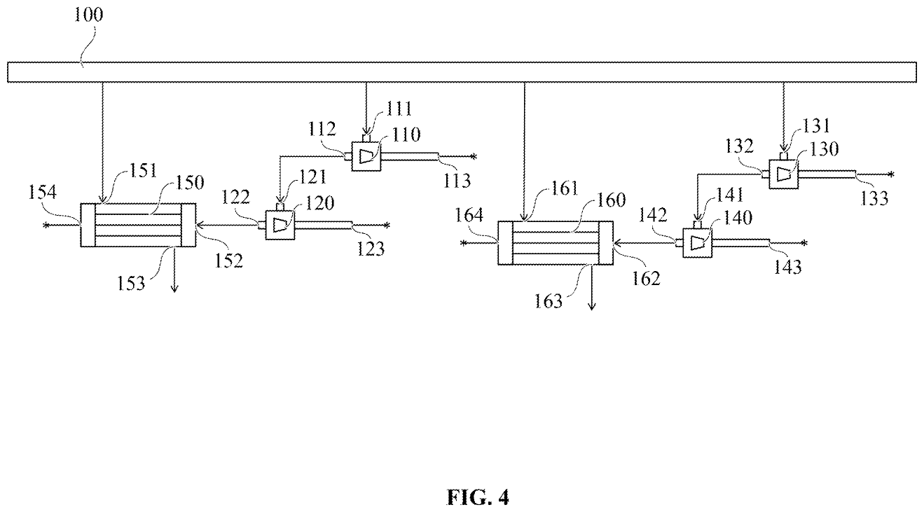

Referring to FIG. 4, in one embodiment of the invention the gas feed line (100) is connected to a third vortex tube (130), said third vortex tube (130) is connected to a fourth vortex tube (140), and a second heat exchanger (160) is connected to the fourth vortex tube (140) and the gas feed line (100). In this case the system is configured with the parallel connection of two modular systems.

These two modular systems are connected in parallel to obtain a higher mass flow of cooled gas. In this way, the same temperature and pressure conditions are obtained in the streams coming from the outlets (153 and 163) of the first heat exchanger (150) and the second heat exchanger (160). One of the advantages of the above parallel arrangement is the use of smaller vortex tubes than those used in a single modular system, because they receive smaller mass flows individually.

In an unillustrated embodiment of the invention, where higher mass flow and temperature drop are required, two systems are arranged in parallel in series.

Returning to the modular system consisting of a thermal and mass cascade and a heat exchanger, in one embodiment of the invention the first vortex tube (110) and the second vortex tube (120) and the first heat exchanger (150) are connected to an element which is selected from the group consisting of pressure regulating valve (180), ejector (190), expansion device (200), separation and storage device (210) and combinations thereof.

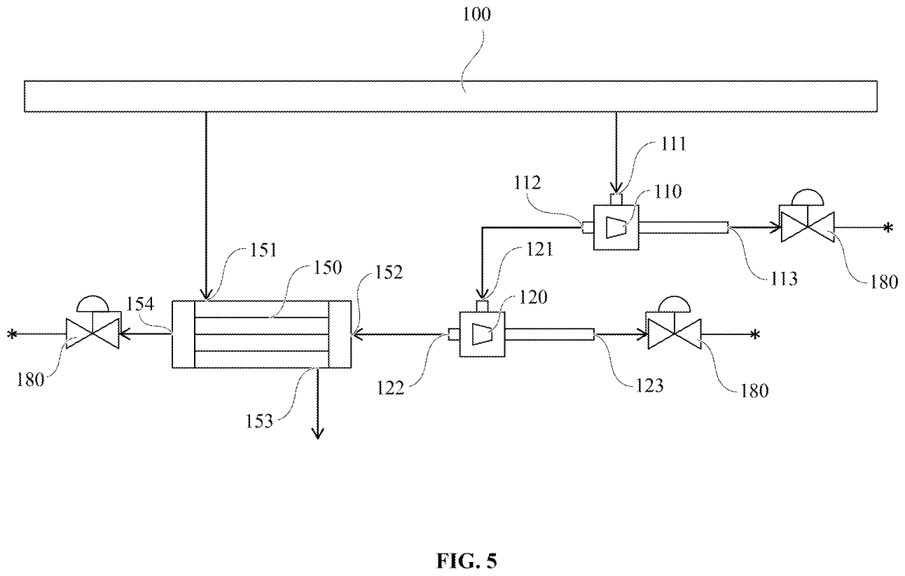

Referring to FIG. 5, in one embodiment of the invention the second outlets (113 and 123) of the first vortex tube (110) and of the second vortex tube (120) and the second outlet (154) of the first heat exchanger (150) are connected to pressure regulating valves (180) to bring said streams to a common pressure or to a desired pressure, individually. This is done in order to take advantage of the gas coming from said outlets (113, 123 and 154) for recirculation, recovery or even to be taken to venting. If these pressure regulating valves (180) were not used, the flows coming out of the outlets (113, 123 and 154) would have to be delivered to systems working with the same pressure of each one of them, which is not really feasible at industrial level.

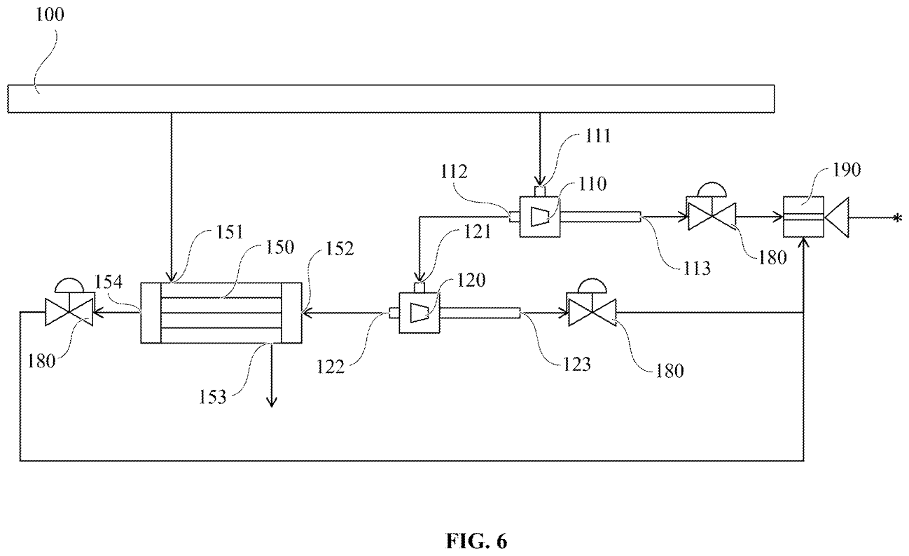

Referring to FIG. 6, in one embodiment of the invention the second outlets (113 and 123) of the first vortex tube (110) and of the second vortex tube (120) and the second outlet (154) of the first heat exchanger (150) are connected to pressure regulating valves (180) and subsequently led to an ejector (190). In this mode, both recovery and recirculation of the waste streams coming from (113, 123 and 154) is carried out. The ejector (190) allows the stream coming from (113) and exiting at an intermediate pressure to suck the fluid from the low-pressure streams coming from (123 and 154), achieving the joint recovery of said streams coming from (113, 123 and 154). On the other hand, the stream coming out of the ejector (190) combines the mass flows of the streams coming from (113, 123 and 154) and presents an intermediate pressure between the three streams. This stream coming from the ejector (190) is recirculated to a system with the same pressure.

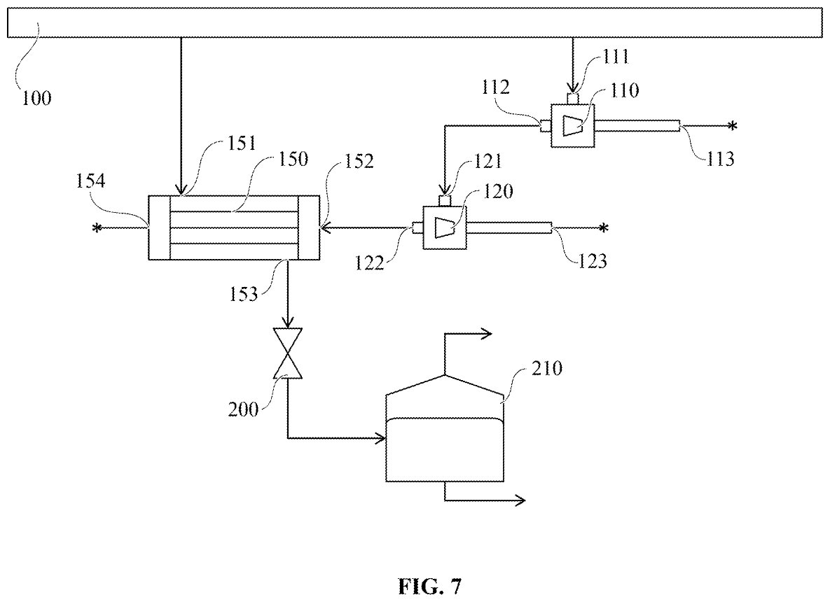

Referring to FIG. 7, in one embodiment of the invention the stream coming from the first outlet (153) of the first heat exchanger (150), which is at high pressure and low temperature with respect to any other stream in the system, crosses through an expansion valve (200). One of the purposes of the foregoing is to lower the pressure of said stream and cool the fluid to a liquid-gas mixture state, wherein the liquid percentage varies between 0.5% and 80.0%. In an example of the invention, two or more consecutive expansion valves (200) are used. Subsequently said liquid-gas mixture is conveyed to a separation and storage device (210). In an unillustrated embodiment of the invention the liquid stored in the separation and storage device (210) is taken to another expansion valve (200) to decrease its pressure again and it is subsequently deposited in a final separation and storage device (210).

It is worth mentioning that the number of expansion valves (200) and separation and storage devices (210) through which the stream coming from (153) flows will depend on the liquefied gas temperature and pressure values established by the industry or by a person moderately versed in the matter. Therefore, the configuration of the expansion valves (200) and the separation and storage devices (210) will vary according to the treated gas and its desired physical properties.

On the other hand, the gas stored in the separation and storage devices (210) is at low pressure and low temperature, thus it would serve as a refrigerant to cool one of the waste streams coming out of the second outlets (113, 123 and 154), by means of a heat exchanger.

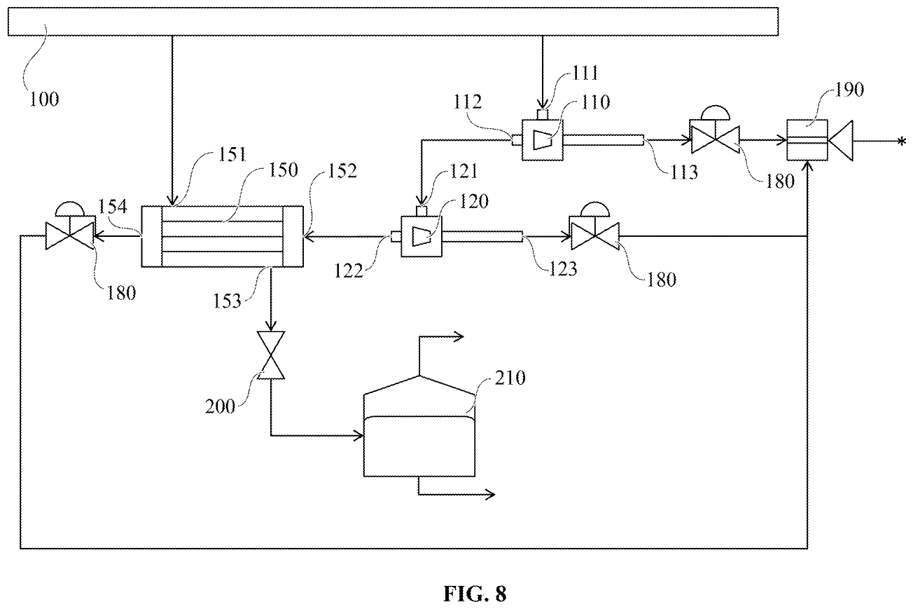

Referring to FIG. 8, in one embodiment of the invention, regulation valves are included for each of the streams coming from the outlets (113, 123 and 154) to be subsequently taken to an ejector (190) which as explained above homogenizes the pressures of said streams. Moreover, the stream leaving the first heat exchanger (150) through the first outlet (153) is brought to a lower pressure and temperature by means of the expansion valve (200). Subsequently, the liquid-gas mixture is conveyed to separation and storage devices (210).

The following are some embodiments of a series-connected cooling and condensing system of the present invention:

In one embodiment of the invention the first vortex tube (110) has a second outlet (113), the second vortex tube (120) has a second outlet (123), the third vortex tube (130) has a second outlet (133), the fourth vortex tube (140) has a second outlet (143), the first heat exchanger (150) has a second outlet (154) and the second heat exchanger (160) has a second outlet (164). Said second outlets (113, 123, 133,143, 154 and 164) are individually or collectively connected to an element which is selected from the group consisting of pressure regulating valves (180), ejectors (190) and combinations thereof.

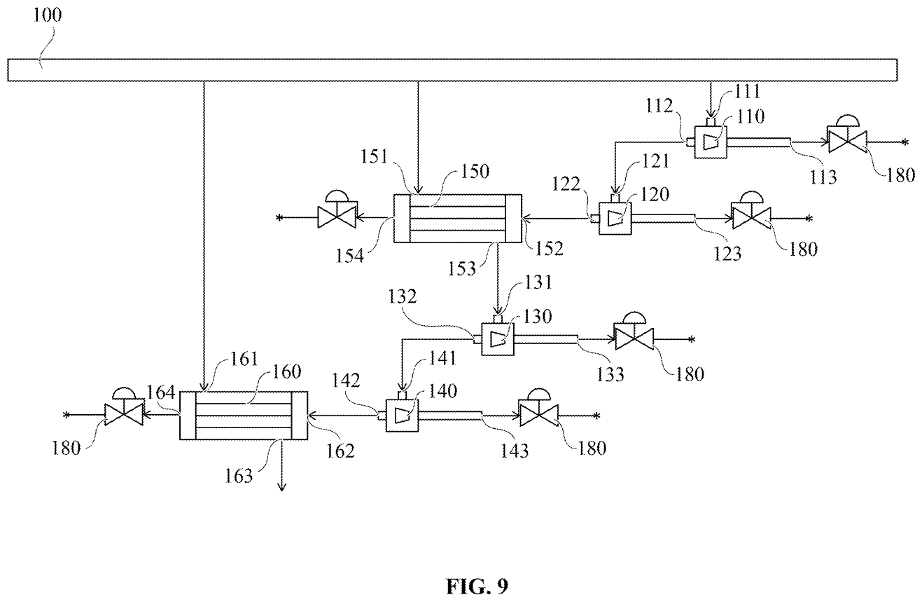

Referring to FIG. 9, in one embodiment of the invention the second outlets (113 123, 133, and 143) of the first vortex tube (110), of the second vortex tube (120), of the third vortex tube (130) and of the fourth vortex tube (140) and the second outlets (154 and 164) of the first heat exchanger (150) and of the second heat exchanger (160) are connected to pressure regulating valves (180) for bringing said streams to a common pressure or to an individually desired pressure. Similarly, as in FIG. 5, this is done in order to tap the gas coming from said outlets (113, 123 and 154) for recirculation, recovery or even to be taken to venting. If these pressure regulating valves (180) were not used, the flows coming out of the outlets (113, 123, 133, 143, 154 and 164) would have to be delivered to systems that work with the same pressure of each one of them, which is not very feasible at industrial level.

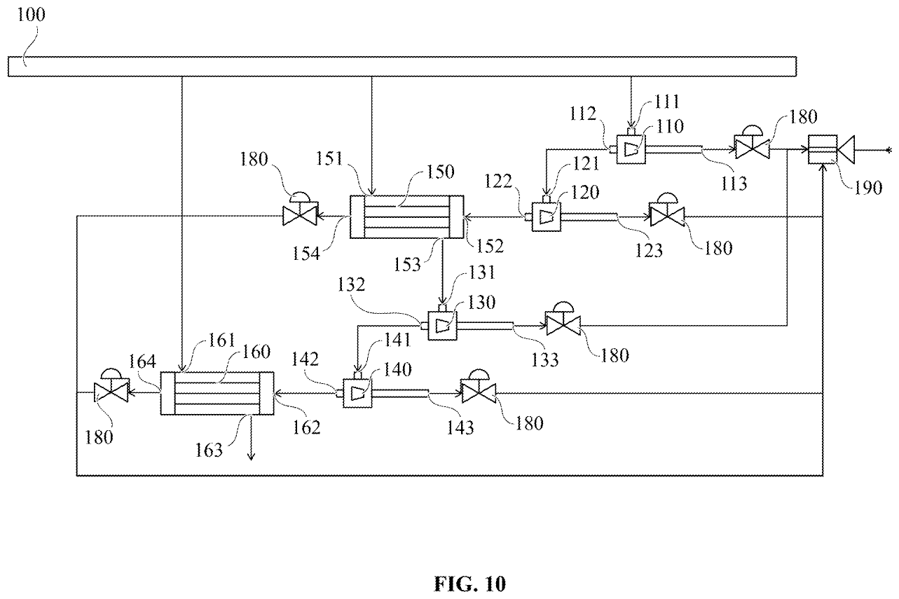

Referring to FIG. 10, in one embodiment of the invention the second outlets (113 123, 133, and 143) of the first vortex tube (110) and of the second vortex tube (120), of the third vortex tube (130) and of the fourth vortex tube (140) and the second outlets (154 and 164) of the first heat exchanger (150) and of the second heat exchanger (160) are connected to pressure regulating valves (180) and subsequently led to an ejector (190). In this embodiment, both recovery and recirculation of waste streams from (113, 123, 133, 143, 154 and 164) is carried out. The ejector (190) allows the streams coming from (113 and 133) and leaving at an intermediate pressure to raise the pressure of the low-pressure streams coming from (123, 143, 154 and 164), achieving the recovery of said streams coming from (113, 123, 133, 143, 154 and 164). The stream coming from the ejector (190) is recirculated to a system having the same pressure.

In the embodiment illustrated in FIG. 10, it is evident that the streams coming from the second outlets (113 and 133) merge into an intermediate pressure line entering the ejector (190), while the streams coming from the second outlets (123, 143, 154 and 164) merge into a low-pressure line, also entering the ejector (190).

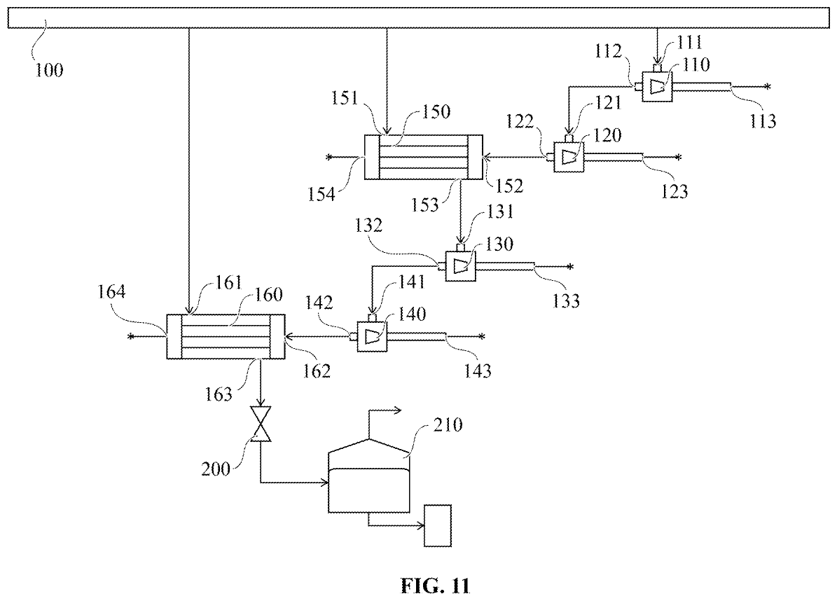

On the other hand, and referring to FIG. 11, in one embodiment of the invention the second heat exchanger (160) has a first outlet (163) connected to an element, which is selected from the group consisting of expansion devices (200), separation and storage devices (210) and combinations of the foregoing.

In a similar way to the embodiment of FIG. 7, in an embodiment of the invention illustrated in FIG. 11, the stream coming from the first outlet (163) of the second heat exchanger (160), being at high pressure and low temperature with respect to any other system stream, crosses through an expansion valve (200). Due to the foregoing the pressure of said stream is lowered and the fluid is cooled to a liquid-gas mixture state, where the percentage of liquid varies between 0.5% and 80.0%. Subsequently said liquid-gas mixture is taken to a separation and storage device (210). In an unillustrated embodiment of the invention, the liquid stored in the separation and storage device (210) is taken to another expansion valve (200) to again decrease its pressure and it is subsequently deposited in a final separation and storage device (210). As in the embodiment of FIG. 7, it is possible to use two or more consecutive expansion valves (200).

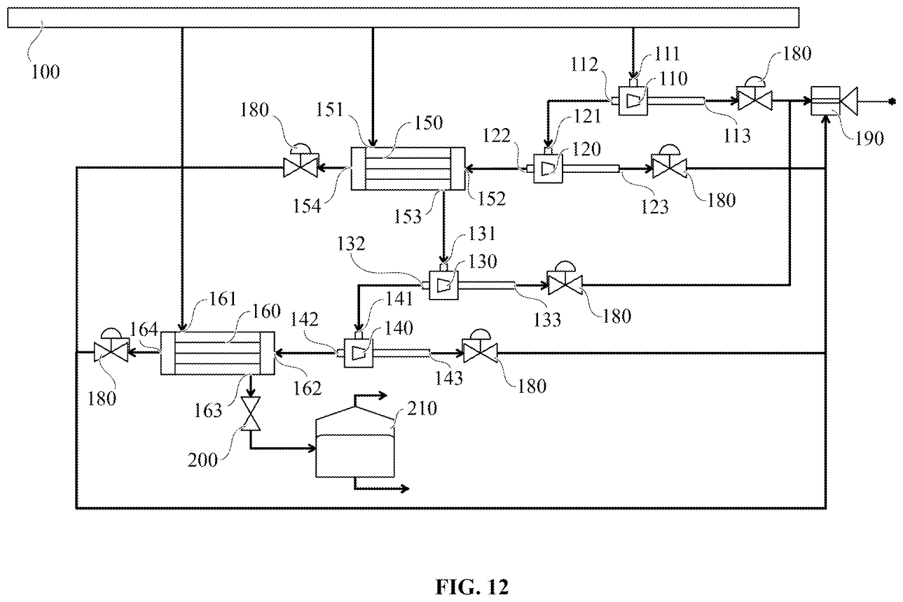

Referring to FIG. 12, in one embodiment of the invention, regulation valves are included for each of the streams coming from the outlets (113, 123, 133, 143, 154 and 164) to be subsequently taken to an ejector (190) which as explained above homogenizes the pressures of said streams. Moreover, the stream leaving the second heat exchanger (160) through the first outlet (163) is brought to a lower pressure and temperature by means of the expansion valve (200). Subsequently the liquid-gas mixture is conveyed to separation and storage devices (210). This is done in a manner similar to FIG. 8, with the difference that the present embodiment is two modular systems connected in series.

For modalities where two modular systems are connected in parallel, it is also possible to use connections to elements that allow recirculation, recovery, separation and storage such as those used in FIG. 5 to FIG. 12.

According to the foregoing, in one embodiment of the invention where the system has two modules in parallel as presented in FIG. 4, the outlets (113, 123, 133,143, 154 and 164) are connected individually or collectively to an element which is selected from the group consisting of pressure regulating valves (180), ejectors (190) and combinations of the foregoing.

On the other hand, also in an embodiment of the invention where the system has two modules in parallel as presented in FIG. 4, the first heat exchanger (150) has a first outlet (153) and the second heat exchanger (160) has a first outlet (163), and said first outlets (153 and 163) are individually or collectively connected to an element, which is selected from the group consisting of expansion devices (200), separation and storage devices (210) and combinations of the foregoing.

Moreover, in a non-illustrated embodiment where a system of modules is arranged in parallel, regulation valves are included for each of the streams coming from the outlets (113, 123, 133, 143, 154 and 164) to be subsequently conveyed to an ejector (190) which, as explained above, homogenizes the pressures of said streams. Furthermore, the streams leaving the first heat exchanger (150) and the second heat exchanger (160) through the outlets (153 and 163) are brought to a lower pressure and temperature by means of the expansion valve (200) individually or collectively. Subsequently the liquid-gas mixture obtained from this passage through the expansion valves (200) is conveyed to separation and storage devices (210).

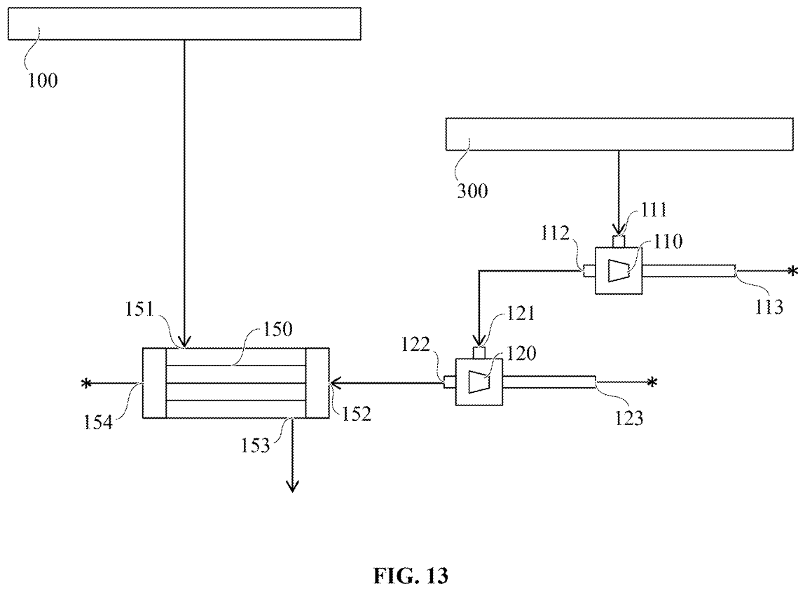

Referring to FIG. 13, in one embodiment of the invention a second gas feed line (300) additional to the gas feed line (100). It is possible that said gas feed lines (100 and 300) present different characteristics, such as being continuous or discontinuous, containing an equal gas but at different pressure or containing different gases, the latter would allow, for example, to cool a gas coming from the second gas feed line (300) allowing higher temperature drops and to use it as a coolant for the gas coming from the gas feed line (100).

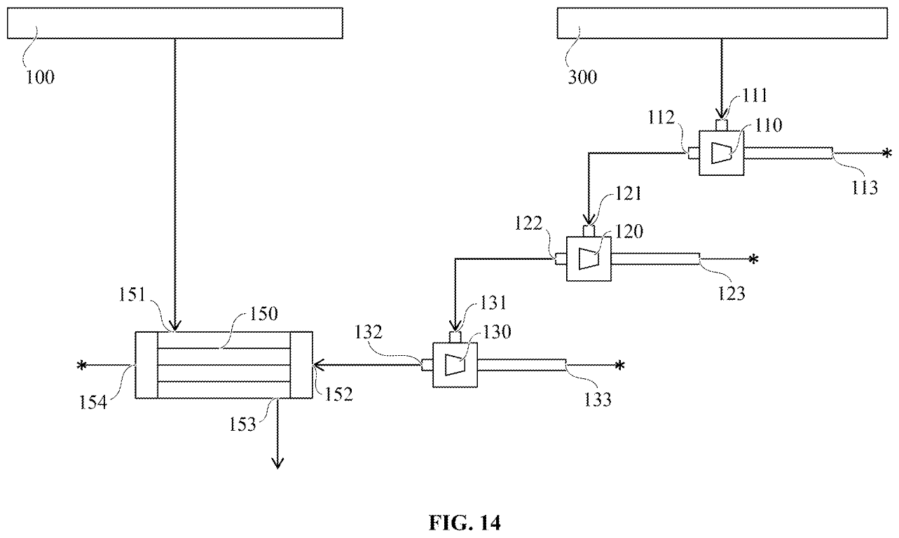

Referring to FIG. 14, in one embodiment of the invention there is a thermal cascade of three vortex tubes (110, 120 and 130) and a second gas feed line (300) moreover to the gas feed line (100). In this modality the gas feed lines (100 and 300) contain different gases, and the gas of the second gas feed line (300) allows, due to its operating condition or its nature, higher pressure drop ratios than the gas of the line (100), which allows implementing a greater number of vortex tubes in cascade or cooling modules operating at lower inlet pressure than the gas feed line (100), in such a way that it is ideal to be used as a coolant for the gas coming from the gas feed line (100). This is possible because the first heat exchanger (150) is closed and does not allow mixing of the gases, only heat exchange between them. An application of this embodiment would be one where the second gas feed line (300) contains compressed air that is cooled by a thermal cascade of three vortex tubes (110, 120, 130) and it is used to cool natural gas coming from a gas feed line (100). The optimum ratio for compressed air between inlet pressure and outlet pressure is 0.528 and for natural gas is 0.54, which are very similar. However, if the compressed air enters through (300) at 1.38 MPa, and its discharge may be at atmospheric pressure (101 kPa) because it is not a noxious gas, it is possible to perform a greater number of thermal and pressure jumps with vortex tubes, obtaining the same or colder compressed air than if it were carried out with natural gas, so that the cooling of natural gas from the gas feed line (100) is greater. Therefore, the cooling effect that would be obtained with natural gas at an inlet pressure of 4.48 MPa and an outlet pressure of 0.8 MPa is similar to that obtained with compressed air at an inlet pressure of 1.37 MPa and an outlet pressure of 0.24 MPa. This is an advantage, if compressed air is available in an industrial facility.

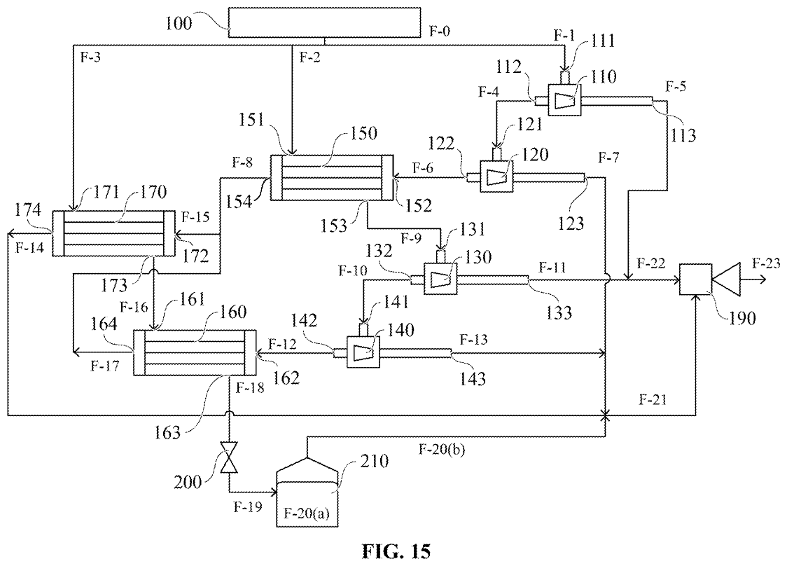

On the other hand, and referring to FIG. 15, in a preferred embodiment of the invention moreover to having the two modular systems in series including four vortex tubes (110, 120, 130 and 140) and two heat exchangers (150 and 160), a third heat exchanger (170) is included. The stream (F-17) coming from the second outlet (164) of the second heat exchanger (160) feeds the second inlet (172) of the third heat exchanger (170) together with the stream (F-8) coming from the second outlet (154) of the first heat exchanger (150). In such a way that the stream (F-15) cools the stream (F-3) coming from the gas feed line (100). In this embodiment the third heat exchanger (170) performs the function of a heat recuperator, i.e., it is a pre-cooling heat exchanger since it uses the streams (F-17 and F-8) which are at lower temperature than (F-0) to cool the fraction (F-3). On the other hand, the second heat exchanger (160) would be the cooling exchanger.

On the other hand, it is worth noting that it is possible to take stream (F-8) to stream (F-14) or to stream (F-15) according to the system requirements. It is also possible to take the stream (F-13) both to (F-17) and to join with (F-7, F-14 and F-20(b)), these two variations respond to the mass flows that are established for the fourth vortex tube (140) from which the stream (F-13) comes. For example, if the mass flow out of the second outlet (143) is greater than the mass flow out of the first outlet (142), it is convenient to bring the stream (F-13) into the stream (F-17), to increase the mass flow of the gas that cools the stream (F-3). In contrast, if the mass flow out of the second outlet (143) is less than the mass flow out of the first outlet (142), it is desirable to bring the stream (F-13) to join with the streams (F-7, F-14 and F-20(b)) to recover by means of the ejector (190).

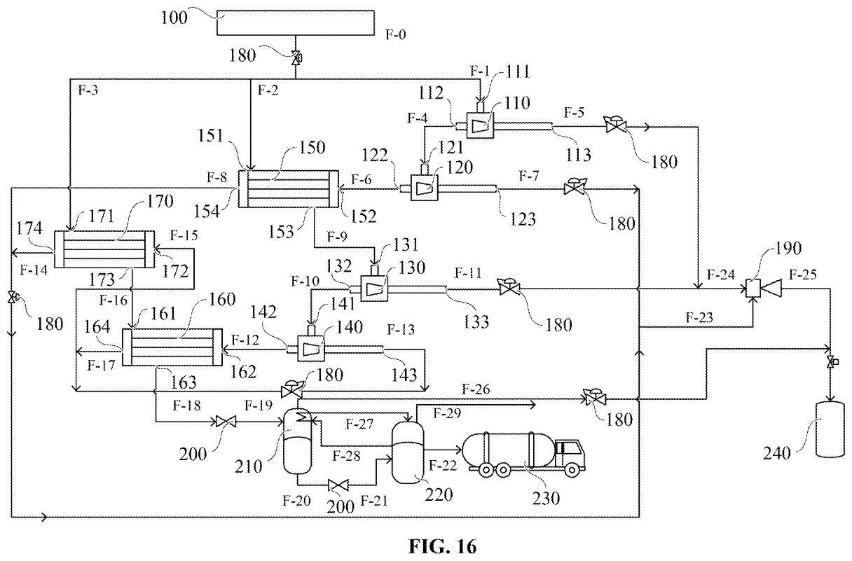

Referring to FIG. 16, in one embodiment of the invention the gas feed line (100) is connected to a regulating valve (180), because it is required to stabilize the variable pressure that would possibly be delivered by a source used as a gas feed line (100). Said regulating valve (180) connected to the gas feed line (100) is optional but represents an improvement in the operation of the system.

On the other hand, the stream (F-18) coming out of the first outlet (163) of the second heat exchanger (160) is taken to an expansion valve (200) and then to a separation tank (210) which has an intermediate pressure where we obtain a stream of liquid F-20 and a stream of gas F-26. The liquid stream F-20 is taken to an expansion valve (200) where its pressure is lowered and then it is taken to a second separation tank (220), while the gas stream F-26 is joined to the stream coming from the ejector (190), for recirculation. The separation tank (220) holds more liquid content than the separation tank (210), however it also contains gas. The gas stream (F-27) from the separation tank (220) is recirculated to the separation tank (210), and because the gas in the stream (F-27) is cooler than the gas in the separation tank (210), the stream (F-27) helps condense the gas in the tank (210), producing more liquid.

On the other hand, the gas stream (F-29) emerging from the tank (220) is an excess of gas that is let out in a non-continuous way to reestablish the pressure inside the tank (220) and compensate the heat gain entering the tank (220) coming from the tank (210). Furthermore, the gas stream (F-29) leaving the tank (220) is the product of evaporation undergone by the liquid which needed excess heat to become gas, this has a cooling effect since all heat gain from the tank (210) is converted into gas. In a particular example of the invention the gas that is vented daily in stream F-29 corresponds to between 0.15% and 0.2% of the stored mass.

Finally, the liquefied gas (F-22) that presents the specific properties required by the industry is taken from the tank (220) to a tank (230) for transportation, although it is also possible that the stream (F-22) is stored. On the other hand, the tank (240) stores the gas coming from the ejector (190), which presents an average pressure between the pressures of the streams (F-24 and F-23). This tank (240) may be a pressure stabilization tank which feeds an external recirculation system.

The configuration illustrated in FIG. 16 is the preferred embodiment of the present invention and features pressure energy recovery in the ejector (190), thermal energy recovery in the third heat exchanger (170) and thermal energy recovery by gas recirculation between the tank (210) and the tank (220) which increases liquid production.

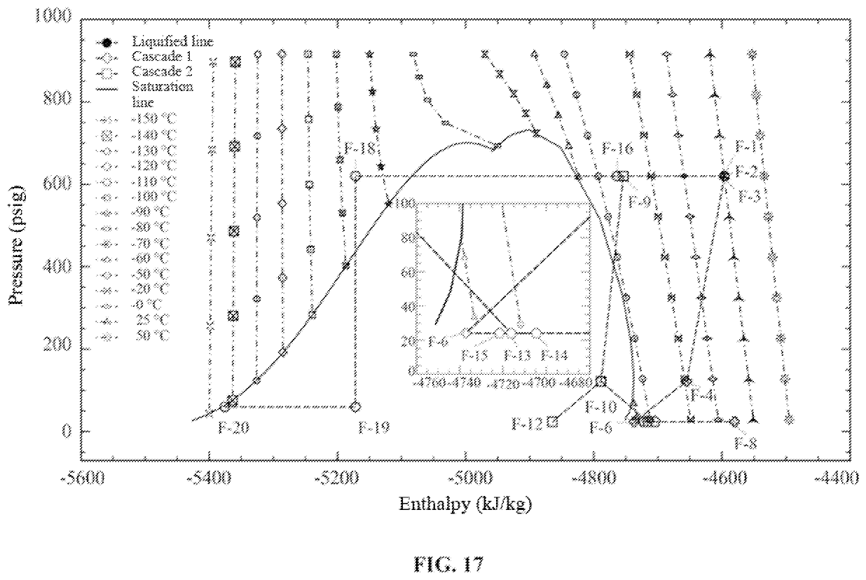

The graph in FIG. 17, which relates to the preferred embodiment in FIG. 16 where natural gas is used, is explained below.

The area at the upper right of the graph, outside the saturation line and at an enthalpy greater than −5000 KJ/kg represents a vapor phase zone, the phase in which the natural gas would be found given the indicated pressures and temperature lines. On the other hand, the region observed in the upper left part of the graph, outside the saturation line and at an enthalpy less than −5000 KJ/kg represents a liquid phase zone, the phase in which the natural gas would be found given the indicated pressures and temperature lines. The area below the saturation line represents a vapor-liquid mixing zone.

Point F-1, F-2 and F-3 show the high-pressure condition (4.25 MPa) at which the natural gas enters the cooling and condensing system of FIG. 16, with a temperature of 25° C. If expansion were carried out at these points, the gas pressure and temperature would drop, but it would not reach the liquid phase zone.

In the cooling and condensing system shown in FIG. 16, F-4 is the outlet of the first vortex tube where a first pressure and temperature drop occur. In the second vortex tube, there is a second pressure and temperature drop evidenced by stream F-6. Subsequently the F-2 stream exchanges heat with F-6, obtaining an F-9 stream with the same high pressure 30 (4.25 MPa) but lower temperature. If the F-9 stream were to undergo expansion, the gas would reach the vapor-liquid mixing zone, but at this point the liquid production would be very low. For this reason, the F-9 stream re-enters a thermal cascade to obtain the F-12 stream. This stream F-12 exchanges heat with the high-pressure stream F-3 and in this way a stream F-18 is obtained, which upon expansion will reach a higher liquid production than the one reached when expanding the streams (F-1, F-2 or F-3). Therefore, the F-19 stream is taken to a tank that separates the phases obtaining the F-20 stream which is the liquefied gas at low pressure and low temperature (−140° C.).

### Glossary

For the understanding of the present invention the following terms will be defined:
Vortex tube: device that divides a fluid stream into two streams, one with a lower temperature than the temperature of the inlet stream, and the other with a higher temperature than the temperature of the inlet stream.
Thermal and mass cascade: configuration of at least two vortex tubes that decrease the temperature of an initial fluid stream, where the “cold” outlet of the first vortex tube is connected to the inlet of the second vortex tube.
High pressure: Pressure of a gas stream in a compressed gas system, before undergoing a pressure drop.
Intermediate pressure: Pressure obtained after a gas stream experiences one or more pressure drops within a compressed gas system.
Low pressure: Pressure obtained after a gas stream experiences all the pressure drops in a compressed gas system.
Recovery: Restoration of the pressure and/or temperature magnitudes of a compressed gas stream by means of another stream energy.
Recirculation: Injection of a gas stream into a system having the same approximate pressure.
Venting: Emission of a gas into the atmosphere.

### EXAMPLE 1

Referring to FIG. 16 and FIG. 17, a natural gas cooling and liquefaction system with the following characteristics was designed and simulated:

Three shell and tube heat exchangers (150, 160 and 170) were used, through which natural gas from a gas feed line (100) was cooled to 4.25 MPa pressure. The heat exchangers (150, 160, 170) were specified as shell and tube, with fixed A-type header, fixed tube plate and removable U-tube bank.

The required cooling gas was obtained from the same gas feed line (100) and was cooled by two arrangements of vortex tubes or thermal cascades. The first thermal cascade used 1004.13 m3/h of gas from the main feed line (100) and allowed obtaining 160.66 m3/h of gas at pressure conditions of 165 kPa and temperature of −62.60° C. (stream F-6, FIG. 16). On the other hand, the second thermal cascade uses as feed line the stream that has been previously cooled in the first heat exchanger (150) (160.66 m3/h, stream F-9, FIG. 16) allowing to generate a theoretical stream of 25.71 m3/h at 165 kPa and −123.90° C. (stream F-12, FIG. 16).

The main characteristics of the streams in the cooling line are shown below:

| | Pressure | Temperature | Flow |
|---|---|---|---|
| Stream | kPa | ° C. | m3/h |
| F-1 | 4274.75 | 25.00 | 1004.13 |
| F-2 | 4274.75 | 25.00 | 160.66 |
| F-3 | 4274.75 | 25.00 | 7.70 |
| F-4 | 841.16 | −18.80 | 401.65 |
| F-5 | 841.16 | 52.60 | 602.47 |
| F-6 | 165.47 | −62.60 | 160.66 |
| F-7 | 165.47 | 8.80 | 240.99 |
| F-8 | 165.47 | 11.41 | 160.66 |
| F-9 | 4274.75 | −36.30 | 160.66 |
| F-10 | 841.16 | −80.10 | 64.26 |
| F-11 | 841.16 | −8.70 | 96.40 |
| F-12 | 165.47 | −123.90 | 25.71 |
| F-13 | 165.47 | −52.50 | 38.55 |
| F-14 | 165.47 | −46.92 | 64.26 |
| F-15 | 165.47 | −55.10 | 64.26 |
| F-16 | 4274.75 | −40.00 | 7.70 |
| F-17 | 165.47 | −60.54 | 25.71 |
| F-18 | 4274.75 | −96.00 | 7.70 |
| F-23 | 165.47 | 2.15 | 465.92 |
| F-24 | 841.16 | 44.34 | 698.87 |
| F-25 | 517.11 | 25.86 | 1164.79 |

The context of the present example is one where it is required to bring natural gas from a transport pressure to a distribution pressure. Low pressure gas is obtained in the streams that leave the second outlets (143 and 123) while the pressure drop is used to cool and condense a portion of said natural gas, which will later be used in other applications.

The liquefied natural gas obtained from the first outlet (163) of the second heat exchanger (160) is at high pressure and cannot be considered commercial liquefied gas. Therefore, it is sought to bring this liquefied natural gas to lower pressure by means of the expansion (200) and separation and storage devices (210, 220, 230).

The liquid-gas mixture obtained from the outlet (153) has a liquid percentage that varies between 5%-7% of the total mass flow entering from the gas feed line (100).

This is considerable, considering that in the case where the stream from the gas feed line (100) was taken to an expansion valve (200) directly, a liquid percentage of about 0.5% would be obtained. This corresponds to what is explained in FIG. 17.

In the case of natural gas, the maximum thermal and pressure utilization occurs when the outlet pressure (low pressure) is a maximum of 57% of the inlet pressure (high pressure), restricting the number of possible thermal jumps.

It shall be understood that the present invention is not limited to the modes described and illustrated, for as will be evident to a person skilled in the art, there are possible variations and modifications which do not depart from the invention spirit, which is only defined by the following claims.

What is claimed is:

1. A system for cooling and condensing gas comprising:
a gas supply line;
a first vortex tube with a first output and with an input, where the input is connected to the gas supply line;
a second vortex tube with a first output and an input, where the input is connected to the first output of the first vortex tube; and
a first heat exchanger connected to the first exit of the second vortex tube and to the gas feed line;
where the connection between the first outlet of the first vortex tube and the inlet of the second vortex tube generates a mass cascade; and
where the gas cooling and condensing system is a modular system.

2. The system of claim 1, wherein the first heat exchanger is connected to a third vortex tube said third vortex tube is connected to a fourth vortex tube, and a second heat exchanger is connected to the fourth vortex tube and the gas feed line 1.

3. The system of claim 1, wherein the gas feed line is connected to a third vortex tube said third vortex tube is connected to a fourth vortex tube, and a second heat exchanger is connected to the fourth vortex tube and the gas feed line.

4. The system of claim 1, wherein the first vortex tube and the second vortex tube and the first heat exchanger are connected to an element which is selected from the group consisting of pressure regulating valve, ejector expansion device, separation and storage device and combinations of the foregoing.

5. The system of claim 2, wherein the first vortex tube has a second outlet, the second vortex tube has a second outlet, the third vortex tube has a second outlet, the fourth vortex tube has a second outlet, the first heat exchanger has a second outlet and the second heat exchanger has a second outlet, and said second outlets are connected to a single element which is selected from the group consisting of pressure regulating valves, ejectors and combinations of the foregoing.

6. The system of claim 2, wherein the first vortex tube has a second outlet, the second vortex tube has a second outlet, the third vortex tube has a second outlet, the fourth vortex tube has a second outlet, the first heat exchanger has a second outlet and the second heat exchanger has a second outlet, and each of said second outlets is connected independently to an element which is selected from the group consisting of pressure regulating valves ejectors and combinations of the foregoing.

7. The system of claim 2, wherein the second heat exchanger has a first outlet connected to an element which is selected from the group consisting of expansion devices, separation and storage devices and combinations of the foregoing.

8. The system of claim 3, wherein the first vortex tube has a second outlet, the second vortex tube has a second outlet, the third vortex tube has a second outlet, the fourth vortex tube has a second outlet, the first heat exchanger has a second outlet and the second heat exchanger has a second outlet, and said second outlets are connected to a single element which is selected from the group consisting of pressure regulating valves, ejectors and combinations of the foregoing.

9. The system of claim 3, wherein the first vortex tube has a second outlet, the second vortex tube has a second outlet, the third vortex tube has a second outlet, the fourth vortex tube has a second outlet, the first heat exchanger has a second outlet and the second heat exchanger has a second outlet, and each of said second outlets are connected independently to an element which is selected from the group consisting of pressure regulating valves ejectors and combinations of the foregoing.

10. The system of claim 3, wherein the first heat exchanger has a first outlet and the second heat exchanger has a first outlet, and said first outlets are connected to a single element which is selected from the group consisting of expansion devices, separation and storage devices and combinations of the foregoing.

11. The system of claim 3, wherein the first heat exchanger has a first outlet and the second heat exchanger has a first outlet, and each of said first outlets are connected independently to an element which is selected from the group consisting of expansion devices, separation and storage devices and combinations of the foregoing.

12. The system of claim 1, wherein the first vortex tube is connected to a secondary gas feed line.

13. The system of claim 2, wherein the gas feed line is connected to a third heat exchanger which is in turn connected to the first heat exchanger and the second heat exchanger.

14. The system of claim 2, wherein the gas feed line is connected to a third heat exchanger which is in turn connected to the second heat exchanger.

15. The system of claim 2, wherein the first heat exchanger and the second heat exchanger are closed.

16. The system of claim 3, wherein the first heat exchanger and the second heat exchanger are closed.
